(19) United States
(12) Patent Application Publication
(10) Pub. No.: US 2023/0194919 A1
(43) Pub. Date: Jun. 22, 2023

(54) POLARIZER, LIQUID CRYSTAL DISPLAY MODULE, AND SIMULATION METHOD FOR LIQUID CRYSTAL DISPLAY COMPENSATION

(71) Applicant: TCL CHINA STAR OPTOELECTRONICS TECHNOLOGY CO., LTD., Shenzhen (CN)

(72) Inventor: Bo Hai, Shenzhen (CN)

(73) Assignee: TCL CHINA STAR OPTOELECTRONICS TECHNOLOGY CO., LTD., Shenzhen (CN)

(21) Appl. No.: 17/420,038

(22) PCT Filed: May 20, 2021
(86) PCT No.: PCT/CN2021/094826

§ 371 Date: Jun. 30, 2021

(30) Foreign Application Priority Data
Jan. 28, 2021 (CN) 20110118594.6

(51) Int. Cl. G02F 1/1335; G02B 5/30

(52) U.S. Cl. CPC G02F 1/133531; G02B 5/3041

(57) ABSTRACT

A polarizer, a liquid crystal display module, and a simulation method for liquid crystal display compensation are disclosed. A compensation film includes three layers of uniaxial compensation films. Each of the three uniaxial compensation films has a slow axis which is configured at a same slow axis angle and is perpendicular to an absorption axis of a polarizing film, and each of the three uniaxial compensation films has only an in-plane phase difference or an out-of-plane phase difference. In this manner, it only needs to adjust thickness of each layer of the compensation film when simulating a design of the compensation film or preparing the polarizer, so that an in-plane phase difference and an out-of-plane phase difference of the compensation film can be separately set at will.

### BACKGROUND OF INVENTION

### 1. Field of Invention

The present invention relates to a technical field of displays, and more particularly to a polarizer, a liquid crystal display module, and a simulation method for liquid crystal display compensation.

### 2. Related Art

With development of liquid crystal display technologies, thin-film transistor liquid crystal displays (TFT-LCDs) have become a mainstream of liquid crystal displays. Recognition of TFT-LCDs in markets greatly depends on their contrast, which is a ratio of displays' bright state to dark state. Generally, the dark state not being dark enough is a main factor adversely affecting the contrast of TFT-LCDs. However, as viewing angles of TFT-LCDs increase, contrast of images continues to decrease, and clarity of the images will be reduced correspondingly. This is because birefringence of liquid crystal molecules in TFT-LCD liquid crystal layers changes with observation angles. Wide viewing angle compensation films are used for compensation, which can effectively reduce light leakage of images in a dark state, and can greatly improve image contrast within certain viewing angles. Generally, a compensation principle of compensation films is to correct phase differences produced by liquid crystals under different viewing angles, so that birefringence properties of the liquid crystal molecules are compensated symmetrically.

For different liquid crystal display modes, the compensation films used are also different, and different liquid crystal optical path differences need to be compensated with different types of compensation films and compensation values. Most of the compensation films used in large-sized liquid crystal displays are aimed at vertical alignment (VA) display modes. The N-TAC of Konica was used in the early days, and later it developed into Zeonor of OPOTES, F-TAC series of Fujitsu, X-plate of Nitto Denko, etc. Currently, commonly used compensation structures for VA display modes include a layer of biaxial compensation film disposed between a liquid crystal display panel and a first polarizing film and a second polarizing film. Dual layer biaxial compensation films cooperatively compensate for problems of light leakage in the dark state and color shift at large viewing angles in the VA display modes. Biaxial compensation films include an in-plane phase difference Ro and an out-of-plane phase difference Rth, both of which will affect light leakage at large viewing angles in the dark state. In this manner, when designing compensation values of compensation films, it is necessary to design the in-plane phase difference Ro and the out-of-plane phase difference Rth of the compensation films at a same time. However, different liquid crystal optical path differences require compensation films with different compensation values to compensate, so simulation design is often performed on the compensation films. When doing the simulation design of the compensation films, it is necessary to change the in-plane phase difference Ro and the out-of-plane phase difference Rth to simulate influence of the compensation films on light leakage and color shift at large viewing angles in the dark state.

The in-plane phase difference Ro and the out-of-plane phase difference Rth of the compensation film generally satisfy a following relational expression with a refractive index (Nx, Ny, Nz) of the compensation film and thickness of the compensation film:

Ro=(Nx−Ny)*d;

Rth=[(Nx+Ny)/2−Nz]*d;

Specifically, Nx is a refractive index in an X direction as a maximum refractive index given in a compensation film plane, Ny is a refractive index in a Y direction orthogonal to the X direction in the compensation film plane, Nz is a refractive index in a thickness direction of the compensation film, and d is a thickness of the compensation film.

As a result, compensation values of the compensation film can be varied by following methods:

Method 1: the refractive index Nx, Ny, Nz remain unchanged, and the thickness d is changed to vary the compensation values; and

Method 2: Keep the thickness d unchanged, and change the refractive index Nx, Ny, Nz to vary the compensation values.

Through the simulation of simulation software, it can be known that Method 1 directly changes the thickness, which is the simplest and fastest, and can quickly obtain different compensation values, but the compensation values Ro and Rth change in a same proportion, and cannot be simulated separately. Method 2 is performed by changing the refractive index, so that the simulation of the compensation values Ro and Rth can be set at will, respectively, but a new model is required for setting each of the compensation values Ro, Rth, so the efficiency of changing settings of original refractive indexes Nx, Ny, Nz of the compensation film is very low.

Therefore, it is imperative to solve a problem of how to separately set the compensation values Ro, Rth at will in a simple and quick manner when designing compensation film simulations.

### SUMMARY OF INVENTION

An object of the present application is to provide a polarizer, a liquid crystal display module, and a simulation method for liquid crystal display compensation to alleviate a technical problem that current compensation film simulation design cannot achieve separate settings for compensation values Ro, Rth at will in a simple and quick manner.

In order to overcome the above problems, the application provides technical solutions as follows:

An embodiment of the present application provides a polarizer, comprising a polarizing film; a compensation film disposed on a side of the polarizing film and comprising a first uniaxial compensation film, a second uniaxial compensation film, and a third uniaxial compensation film, wherein the second uniaxial compensation film is disposed between the first uniaxial compensation film and the third uniaxial compensation film, and an in-plane phase difference of the first uniaxial compensation film, an in-plane phase difference of the third uniaxial compensation film, and an out-of-plane phase difference of the second uniaxial compensation film are defined as a first preset value; and a protective film disposed on a side of the polarizing film away from the compensation film; wherein each of the first uniaxial compensation film, the second uniaxial compensation film, and the third uniaxial compensation film has a same slow axis angle, and an angle between a slow axis of each of the first uniaxial compensation film, the second uniaxial compensation film, and the third uniaxial compensation film and an absorption axis of the polarizing film is defined as a second preset value.

In the polarizer provided by an embodiment of the present application, the first preset value is zero.

In the polarizer provided by an embodiment of the present application, the second preset value is 90 degrees.

An embodiment of the present application further provides a liquid crystal display module, comprising a liquid crystal display panel; a first polarizer disposed on a side of the liquid crystal display panel; and a second polarizer disposed on a side of the liquid crystal display panel away from the first polarizer; wherein the first polarizer comprises the polarizer in the above-mentioned embodiment, and an absorption axis of a polarizing film included in the first polarizer is perpendicular to an absorption axis of a polarizing film included in the second polarizer.

In the liquid crystal display module provided by an embodiment of the present application, the absorption axis of the polarizing film of the first polarizer is zero degrees with respect to an incident light direction.

In the liquid crystal display module provided by an embodiment of the present application, the absorption axis of the polarizing film of the first polarizer is 90 degrees with respect to an incident light direction.

In the liquid crystal display module provided by an embodiment of the present application, the second polarizer comprises the polarizer in the above-mentioned embodiment.

In the liquid crystal display module provided by an embodiment of the present application, the first preset value is zero.

In the liquid crystal display module provided by an embodiment of the present application, the second preset value is 90 degrees.

An embodiment of the present application further provides a simulation method for liquid crystal display compensation, comprising selecting a target compensation film framework according to a simulation request, wherein the target compensation film framework comprises a first uniaxial compensation film, a second uniaxial compensation film, and a third uniaxial compensation film, wherein the second uniaxial compensation film is disposed between the first uniaxial compensation film and the third uniaxial compensation film, and an in-plane phase difference of the first uniaxial compensation film, an in-plane phase difference of the third uniaxial compensation film, and an out-of-plane phase difference of the second uniaxial compensation film are defined as a first preset value, and wherein each of the first uniaxial compensation film, the second uniaxial compensation film, and the third uniaxial compensation film has a same slow axis angle; creating a target liquid crystal display (LCD) compensation framework based on the target compensation film framework, wherein the target LCD compensation framework comprises an LCD panel, a first polarizing film, a second polarizing film, a first target compensation film framework disposed between the first polarizing film and the LCD panel, and a second target compensation film framework disposed between the second polarizing film and the LCD panel, wherein an angle between a slow axis of each of film layers included in the first target compensation film framework and an absorption axis of the first polarizing film, and an angle between a slow axis of each of film layers included in the second target compensation film framework and an absorption axis of the second polarizing film are defined as a second preset value; obtaining panel setting parameters, and setting the LCD panel in the target LCD compensation framework according to the panel setting parameters; adjusting thicknesses of uniaxial compensation films included in each of the first target compensation film framework and the second target compensation film framework according to a preset adjustment method, and determining corresponding influence parameters; determining target parameters according to a simulation target; and outputting a simulation result according to correlations between the target parameters and the influence parameters.

In the simulation method for the liquid crystal display compensation by an embodiment of the present application, the first preset value is zero.

In the simulation method for the liquid crystal display compensation by an embodiment of the present application, the second preset value is 90 degrees.

In the simulation method for the liquid crystal display compensation by an embodiment of the present application, the absorption axis of the first polarizing film is perpendicular to the absorption axis of the second polarizing film.

In the simulation method for the liquid crystal display compensation by an embodiment of the present application, the absorption axis of the first polarizing film is zero degrees or 90 degrees with respect to an incident light direction.

In the simulation method for the liquid crystal display compensation by an embodiment of the present application, prior to the selecting a target compensation film framework according to a simulation request, the simulation method further comprises obtaining a standard compensation film simulation framework; creating a standard LCD compensation simulation framework based on the standard compensation film simulation framework; obtaining a standard simulation target curve by simulating the standard LCD compensation simulation framework; obtaining at least two preset compensation film simulation frameworks; creating preset LCD compensation simulation frameworks, respectively, based on the at least two preset compensation film simulation frameworks; obtaining at least a preset simulation target curve by simulating the preset LCD compensation simulation framework; and determining a target compensation film framework from the at least two preset compensation film simulation frameworks according to a comparison result of the preset simulation target curve and the standard simulation target curve.

In the simulation method for the liquid crystal display compensation by an embodiment of the present application, each of the standard LCD compensation simulation framework and the preset LCD compensation simulation framework comprises an LCD panel, and standard panel parameters of the LCD panel of the standard LCD compensation simulation framework are related to preset panel parameters of the LCD panel of the preset LCD compensation simulation framework.

The present application has advantageous effects as follows: the present application provides a polarizer, a liquid crystal display module, and a simulation method for liquid crystal display compensation. A compensation film provided by the present application includes three layers of uniaxial compensation films. Each of the three uniaxial compensation films has a slow axis which is configured at a same slow axis angle and is perpendicular to an absorption axis of a polarizing film, and each of the three uniaxial compensation films has only an in-plane phase difference or an out-of-plane phase difference. In this manner, the present application only needs to adjust thickness of each layer of the compensation film when simulating the compensation film or preparing the polarizer, so that an in-plane phase difference and an out-of-plane phase difference of the compensation film can be separately set at will, which is simple and quick, thereby overcoming the problem that current compensation film simulation design cannot achieve separate settings for compensation values Ro, Rth at will in a simple and quick manner.

### BRIEF DESCRIPTION OF DRAWINGS

To describe the technical solutions in the embodiments of the present invention, the following briefly introduces the accompanying drawings for describing the embodiments. Apparently, the accompanying drawings in the following description show merely some embodiments of the present invention, and a person skilled in the art may still derive other drawings from these accompanying drawings without creative efforts.

FIG. 1 is a schematic cross-sectional view of a film layer structure of a polarizer provided by an embodiment of the present application.

FIG. 2 is a schematic cross-sectional view of a liquid crystal display module provided by an embodiment of the present application.

FIG. 3 is a flowchart of a simulation method for liquid crystal display compensation provided by an embodiment of the present application.

FIG. 4 is a schematic relationship diagram of an in-plane phase difference Ro and brightness provided by an embodiment of the present application.

FIG. 5 is a schematic relationship diagram of the in-plane phase difference Ro and chromaticity X provided by an embodiment of the present application.

FIG. 6 is a schematic relationship diagram of the in-plane phase difference Ro and chromaticity Y provided by an embodiment of the present application.

### DESCRIPTION OF PREFERRED EMBODIMENTS

The following embodiments are referring to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

A polarizer, a liquid crystal display module, and a simulation method for liquid crystal display compensation provided by embodiments of the present application are used to overcome a technical problem that current compensation film simulation design cannot achieve simple, fast, and separate settings for simulating compensation values Ro, Rth at will.

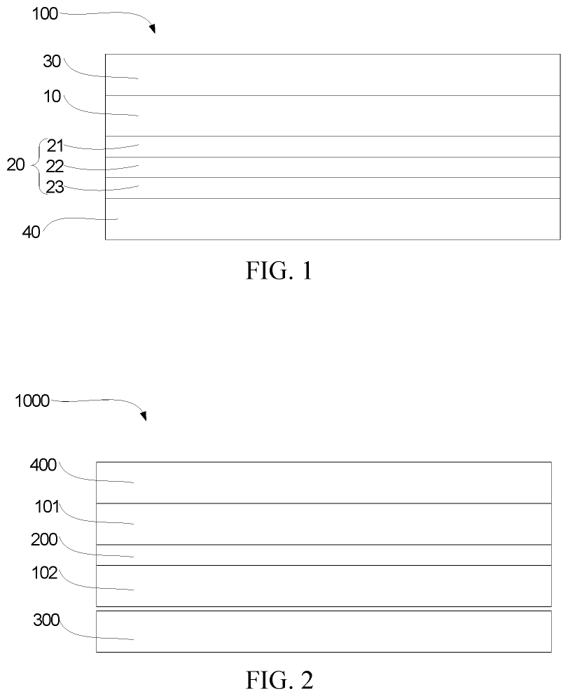

Please refer to FIG. 1, which is a schematic cross-sectional view of a film layer structure of a polarizer provided by an embodiment of the present application. A polarizer 100 includes a polarizing film 10, a compensation film 20, and a protective film 30. Certainly, the polarizer 100 may further include an adhesive film 40, wherein the compensation film 20 is disposed on a side of the polarizing film 10, the protective film 30 is disposed on a side of the polarizing film 10 away from the compensation film 20, and the adhesive film 40 is disposed on a side of the compensation film 20 away from the polarizing film 10.

Specifically, the polarizing film 10 is a PVA layer made of polyvinyl alcohol, and mainly functions to polarize light in the polarizer 100. The protective film 30, namely the triacetyl cellulose (TAC) layer, is mainly used to protect the PVA layer, improve mechanical properties of the PVA layer, and prevent the PVA layer from shrinking. The adhesive film 40 includes pressure sensitive adhesive (PSA), which mainly serves to provide an adhesive and connection function.

The compensation film 20 includes a first uniaxial compensation film 21, a second uniaxial compensation film 22, and a third uniaxial compensation film 23, wherein the second uniaxial compensation film 22 is disposed between the first uniaxial compensation film 21 and the third uniaxial compensation film 23. An in-plane phase difference of the first uniaxial compensation film 21, an in-plane phase difference of the third uniaxial compensation film 23, and an out-of-plane phase difference of the second uniaxial compensation film 22 are defined as a first preset value. Each of the first uniaxial compensation film 21, the second uniaxial compensation film 22, and the third uniaxial compensation film 23 has a same slow axis angle with respect to an incident light direction, and an angle between a slow axis of each of the first uniaxial compensation film 21, the second uniaxial compensation film 22, and the third uniaxial compensation film 23 and an absorption axis of the polarizing film 10 is defined as a second preset value.

Specifically, the first preset value is zero, and the second preset value is 90 degrees.

In this embodiment, the compensation film 20 of the polarizer 100 includes three layers of uniaxial compensation films. The three uniaxial compensation films each has a slow axis configured at the same slow axis angle and being perpendicular to the absorption axis of the polarizing film 10, wherein each of the three uniaxial compensation films has only an in-plane phase difference or an out-of-plane phase difference. Therefore, when designing the compensation film, the in-plane phase difference and the out-of-plane phase difference of the compensation film can be separately set at will by only adjusting thickness of each of the layers of the compensation film, so that there is no need to adjust a refractive index of the compensation film by changing its material to achieve any desired setting for the in-plane phase difference and the out-of-plane phase difference of the compensation film, respectively.

In one embodiment, a liquid crystal display (LCD) module is provided. Please refer to FIG. 2, which is a schematic cross-sectional view of the LCD module provided by the embodiment of the present application. The LCD module 1000 includes an LCD panel 200, a first polarizer 101, and a second polarizer 102. The first polarizer 101 is disposed on a side of the LCD panel 200. The second polarizer 102 is disposed on a side of the LCD panel 200 away from the first polarizer 101, wherein at least one of the first polarizer 101 or the second polarizer 102 includes the polarizer 100 in the above-mentioned embodiments. A compensation film of the first polarizer 101 and/or the second polarizer 102 is located close to the LCD panel 200, and an absorption axis of a polarizing film of the first polarizer 101 is perpendicular to an absorption axis of a polarizing film of the second polarizer 102, that is, an included angle of 90 degrees is formed, such as that the absorption axis of the polarizing film of the first polarizer 101 is zero degrees or 90 degrees with respect to an incident light direction. Certainly, the LCD module 1000 further includes a backlight module 300, a cover 400, and other structures, but these structures are not the focus of this application, so they will not be described here.

In the present application, each of the polarizers of the LCD module 1000 is provided with a compensation film. The compensation film includes three layers of uniaxial compensation films. The three uniaxial compensation films each have a slow axis configured at a same slow axis angle and being perpendicular to the absorption axis of the polarizing film, wherein each of the three uniaxial compensation films has only an in-plane phase difference or an out-of-plane phase difference. Therefore, when designing the compensation film, the in-plane phase difference and the out-of-plane phase difference of the compensation film can be set at will by only adjusting thickness of each of the layers of the compensation film, so that there is no need to adjust a refractive index of the compensation film by changing its material to achieve any desired setting for the in-plane phase difference and the out-of-plane phase difference of the compensation film, respectively.

A simulation design method of a compensation film will be described in detail below:

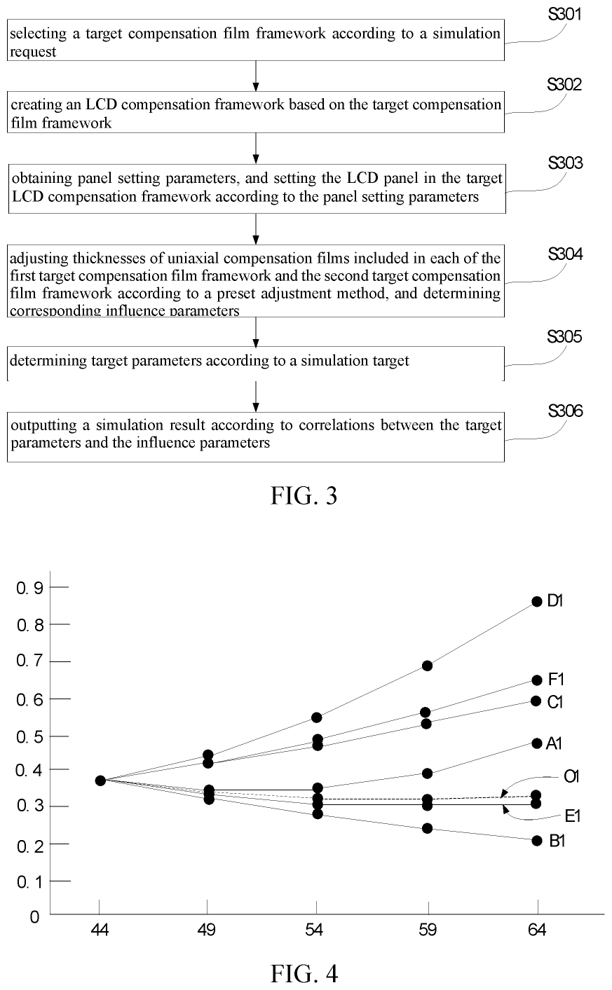

Please refer to FIG. 3, which is a flowchart of a simulation method for liquid crystal display (LCD) compensation provided by an embodiment of the present application. The simulation method for LCD compensation includes steps as follows:

Step S301: selecting a target compensation film framework according to a simulation request. The target compensation film framework is shown in Table 1:

TABLE 1

| | |
|---|---|
| first uniaxial compensation film | Ro = 0 |
| second uniaxial compensation film | Rth = 0 |
| third uniaxial compensation film | Ro = 0 |

Referring to Table 1, the target compensation film framework includes a first uniaxial compensation film, a second uniaxial compensation film, and a third uniaxial compensation film, wherein the second uniaxial compensation film is disposed between the first uniaxial compensation film and the third uniaxial compensation film. An in-plane phase difference of the first uniaxial compensation film, an in-plane phase difference of the third uniaxial compensation film, and an out-of-plane phase difference of the second uniaxial compensation film are defined as a first preset value, wherein the first preset value is zero, that is, the in-plane phase difference of the first uniaxial compensation film is Ro=0, the out-of-plane phase difference of the second uniaxial compensation film is Rth=0, and the in-plane phase difference of the third uniaxial compensation film is Ro=0. Each of the first uniaxial compensation film, the second uniaxial compensation film, and the third uniaxial compensation film has a same slow axis angle.

Specifically, prior to the step of selecting the target compensation film framework according to the simulation request, it is necessary to first select the target compensation film framework as required from multiple preset compensation film simulation frameworks through simulation comparison, wherein the simulation comparison can be performed by simulation software, which includes LCD Master or other professional liquid crystal simulation software. Accordingly, prior to step S301, the simulation method further includes:

Obtain a standard compensation film simulation framework.

The standard compensation film simulation framework includes a biaxial compensation film including an in-plane phase difference Ro and an out-of-plane phase difference Rth, both of which will affect light leakage at large viewing angles in a dark state. Certainly, the standard compensation film simulation framework can also be selected from other types of compensation films, and is not limited in the present application.

Create a standard LCD compensation simulation framework based on the standard compensation film simulation framework.

The standard LCD compensation simulation framework is shown in Table 2:

TABLE 2

| | |
|---|---|
| first polarizing film | absorption axis at 90 degrees |
| first standard compensation film simulation | slow axis at 0 degrees |
| framework | |
| LCD panel | |
| second standard compensation film | slow axis at 90 degrees |
| simulation framework | |
| second polarizing film | absorption axis at 0 degrees |

Referring to Table 2, the standard LCD compensation film simulation framework includes an LCD panel, a first polarizing film, a second polarizing film, a first standard compensation film simulation framework disposed between the first polarizing film and the LCD panel, and a second standard compensation film simulation framework disposed between the second polarizing film and the LCD panel, that is, the standard LCD compensation film simulation framework employs dual layer biaxial compensation films, wherein the LCD panel is configured in a vertical alignment (VA) display mode. An angle between a slow axis of the first standard compensation film simulation framework and an absorption axis of the first polarizing film, and an angle between a slow axis of the second standard compensation film simulation framework and an absorption axis of the second polarizing film are defined as a second preset value, respectively, wherein the second preset value is 90 degrees, and the absorption axes of the first polarizing film and the second polarizing film are perpendicular to each other. As shown in Table 2, the absorption axis of the first polarizing film is configured to be 90 degrees with respect to an incident light direction, and the absorption axis of the second polarizing film is correspondingly configured to be zero degrees with respect to the incident light direction, so that the slow axis of the first standard compensation film simulation framework can be determined to be zero degrees, and the slow axis of the second standard compensation film simulation framework can be determined to be 90 degrees.

Obtain a standard simulation target curve by simulating the standard LCD compensation simulation framework.

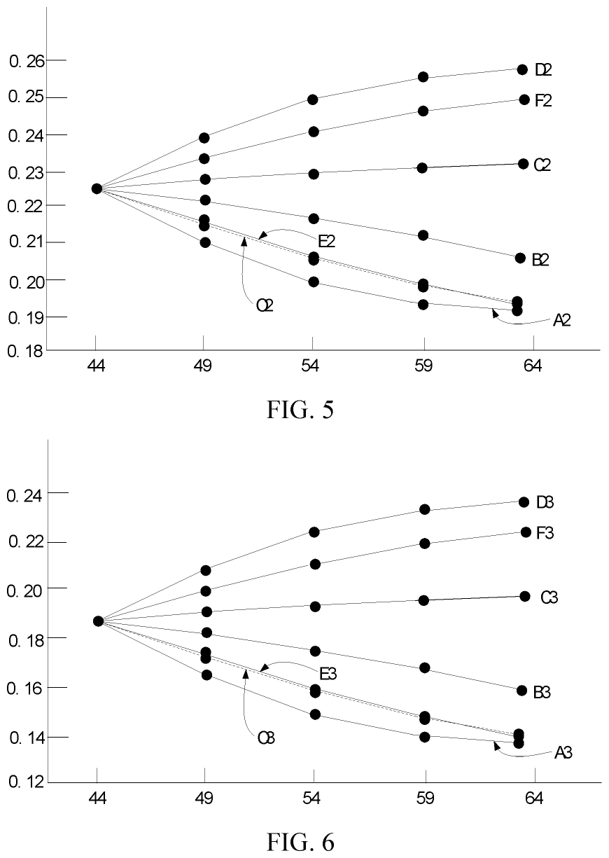

Specifically, the standard LCD compensation simulation framework employs the dual layer biaxial compensation films. The dual layer biaxial compensation films cooperatively compensate for problems of light leakage in the dark state and color shift at large viewing angles in the VA display mode. Different liquid crystal optical path differences need to be compensated with different types of compensation films and compensation values. The dual layer biaxial compensation films of the standard LCD compensation simulation framework have good compensation effects for a specific liquid crystal optical path difference. When simulating the standard LCD compensation simulation framework, specific large viewing angles in the dark state can be selected for the simulation, for example, under the large viewing angles of (45, 60) degrees in the dark state, an out-of-plane phase difference Rth of the biaxial compensation film in the standard LCD compensation simulation framework is set unchanged, corresponding brightness and chromaticity are obtained by changing an in-plane phase difference Ro of the biaxial compensation film, wherein characteristics that determine the chromaticity include chromaticity X and chromaticity Y, and the standard simulation target curve is output according to correlations between the in-plane phase difference Ro and brightness and chromaticity. The correlations between the in-plane phase difference Ro and brightness and chromaticity mean that different in-plane phase differences Ro will correspond to different brightness values and chromaticity values. The standard simulation target curve includes a brightness curve, a chromaticity X curve, and a chromaticity Y curve. Please refer to FIGS. 4 to 6. As a schematic relationship diagram of the in-plane phase difference Ro and the brightness shown in FIG. 4, an abscissa represents a value of the in-plane phase difference Ro, and an ordinate represents a brightness value, and a brightness curve O1 represents different brightness values corresponding to different in-plane phase differences Ro of the standard compensation film simulation framework. As a schematic relationship diagram of the in-plane phase difference Ro and chromaticity X shown in FIG. 5, an abscissa represents the value of the in-plane phase difference Ro, and an ordinate represents a chromaticity value of the chromaticity X, and a curve O2 of the chromaticity X represents different chromaticity values corresponding to the different in-plane phase differences Ro of the standard compensation film simulation framework. As a schematic relationship diagram of the in-plane phase difference Ro and chromaticity Y shown in FIG. 6, an abscissa represents the value of the in-plane phase difference Ro, and an ordinate represents a chromaticity value of the chromaticity Y, and a curve O3 of the chromaticity Y represents different chromaticity values corresponding to the different in-plane phase differences Ro of the standard compensation film simulation framework.

Obtain at least two preset compensation film simulation frameworks.

Specifically, the in-plane phase difference Ro and the out-of-plane phase difference Rth of the biaxial compensation film cannot be set separately, so a compensation film composed of multiple layers for simulation may be designed, for example, a compensation film framework composed of two layers of uniaxial compensation films or three layers of uniaxial compensation films can be used as the preset compensation film simulation framework. In this manner, a variety of preset compensation film simulation frameworks can be created, from which at least two preset compensation film simulation frameworks can be obtained to facilitate simulation comparison with standard compensation film simulation framework.

Create preset LCD compensation simulation frameworks, respectively, based on the at least two preset compensation film simulation frameworks.

A specific method of creating the preset LCD compensation simulation frameworks can refer to the above-mentioned method of creating the standard LCD compensation simulation framework. Each of the created preset LCD compensation simulation frameworks includes an LCD panel, a first polarizing film, a second polarizing film, a first preset compensation film simulation framework disposed between the first polarizing film and the LCD panel, and a second preset compensation film simulation framework disposed between the second polarizing film and the LCD panel, wherein an absorption axis of the first polarizing film is configured to be 90 degrees with respect to the incident light direction, and an absorption axis of the second polarizing film is correspondingly configured to be zero degrees with respect to the incident light direction.

Structures of a plurality of the preset LCD compensation simulation frameworks created will be described in detail below.

Specifically, a first preset LCD compensation simulation framework is shown in Table 3:

TABLE 3

| | |
|---|---|
| first polarizing film | absorption axis at 90 degrees |
| first uniaxial compensation film (Ro = 0) | slow axis at 0 degrees |
| second uniaxial compensation film (Rth = 0) | slow axis at 0 degrees |
| LCD panel | |
| second uniaxial compensation film (Rth = 0) | slow axis at 90 degrees |
| first uniaxial compensation film (Ro = 0) | slow axis at 90 degrees |
| second polarizing film | absorption axis at 0 degrees |

Referring to Table 3, a first preset compensation film simulation framework of the first preset LCD compensation simulation framework includes a first uniaxial compensation film and a second uniaxial compensation film. A slow axis angle of each of the first uniaxial compensation film and the second uniaxial compensation film is zero degrees with respect to the incident light direction, an in-plane phase difference of the first uniaxial compensation film is Ro=0, and an out-of-plane phase difference of the second uniaxial compensation film is Rth=0. A second preset compensation film simulation framework of the first preset LCD compensation simulation framework includes a first uniaxial compensation film and a second uniaxial compensation film. A slow axis angle of each of the first uniaxial compensation film and the second uniaxial compensation film is 90 degrees with respect to the incident light direction, an in-plane phase difference of the first uniaxial compensation film is Ro=0, and an out-of-plane phase difference of the second uniaxial compensation film is Rth=0, wherein the second uniaxial compensation films are located close to the LCD panel, and the first uniaxial compensation films are located close to the first polarizing film or the second polarizing film.

A second preset LCD compensation simulation framework is shown in Table 4:

TABLE 4

| | |
|---|---|
| first polarizing film | absorption axis at 90 degrees |
| second uniaxial compensation film (Rth = 0) | slow axis at 0 degrees |
| first uniaxial compensation film (Ro = 0) | slow axis at 0 degrees |
| LCD panel | |
| first uniaxial compensation film (Ro = 0) | slow axis at 90 degrees |
| second uniaxial compensation film (Rth = 0) | slow axis at 90 degrees |
| second polarizing film | absorption axis at 0 degrees |

Referring to Table 4, a first preset compensation film simulation framework of the second preset LCD compensation simulation framework includes a first uniaxial compensation film and a second uniaxial compensation film. A slow axis angle of each of the first uniaxial compensation film and the second uniaxial compensation film is zero degrees, an in-plane phase difference of the first uniaxial compensation film is Ro=0, and an out-of-plane phase difference of the second uniaxial compensation film is Rth=0. A second preset compensation film simulation framework of the second preset LCD compensation simulation framework includes a first uniaxial compensation film and a second uniaxial compensation film. A slow axis angle of each of the first uniaxial compensation film and the second uniaxial compensation film is 90 degrees, an in-plane phase difference of the first uniaxial compensation film is Ro=0, and an out-of-plane phase difference of the second uniaxial compensation film is Rth=0, wherein the first uniaxial compensation films are located close to the LCD panel, and the second uniaxial compensation films are located close to the first polarizing film or the second polarizing film.

A third preset LCD compensation simulation framework is shown in Table 5:

TABLE 5

| | |
|---|---|
| first polarizing film | absorption axis at 90 degrees |
| second uniaxial compensation film (Rth = 0) | slow axis at 90 degrees |
| first uniaxial compensation film (Ro = 0) | slow axis at 0 degrees |
| LCD panel | |
| first uniaxial compensation film (Ro = 0) | slow axis at 90 degrees |
| second uniaxial compensation film (Rth = 0) | slow axis at 0 degrees |
| second polarizing film | absorption axis at 0 degrees |

Referring to Table 5, a first preset compensation film simulation framework of the third preset LCD compensation simulation framework includes a first uniaxial compensation film and a second uniaxial compensation film. A slow axis angle of the first uniaxial compensation film is zero degrees, a slow axis angle of the second uniaxial compensation film is 90 degrees, an in-plane phase difference of the first uniaxial compensation film is Ro=0, and an out-of-plane phase difference of the second uniaxial compensation film is Rth=0. A second preset compensation film simulation framework of the third preset LCD compensation simulation framework includes a first uniaxial compensation film and a second uniaxial compensation film. A slow axis angle of the first uniaxial compensation film is 90 degrees, a slow axis angle of the second uniaxial compensation film is zero degrees, an in-plane phase difference of the first uniaxial compensation film is Ro=0, and an out-of-plane phase difference of the second uniaxial compensation film is Rth=0, wherein the first uniaxial compensation films are located close to the LCD panel, and the second uniaxial compensation films are located close to the first polarizing film or the second polarizing film.

A fourth preset LCD compensation simulation framework is shown in Table 6:

TABLE 6

| | |
|---|---|
| first polarizing film | absorption axis at 90 degrees |
| first uniaxial compensation film (Ro = 0) | slow axis at 0 degrees |
| second uniaxial compensation film (Rth = 0) | slow axis at 90 degrees |
| LCD panel | |
| second uniaxial compensation film (Rth = 0) | slow axis at 0 degrees |
| first uniaxial compensation film (Ro = 0) | slow axis at 90 degrees |
| second polarizing film | absorption axis at 0 degrees |

Referring to Table 6, a first preset compensation film simulation framework of the fourth preset LCD compensation simulation framework includes a first uniaxial compensation film and a second uniaxial compensation film. A slow axis angle of the first uniaxial compensation film is zero degrees, a slow axis angle of the second uniaxial compensation film is 90 degrees, an in-plane phase difference of the first uniaxial compensation film is Ro=0, and an out-of-plane phase difference of the second uniaxial compensation film is Rth=0. A second preset compensation film simulation framework of the fourth preset LCD compensation simulation framework includes a first uniaxial compensation film and a second uniaxial compensation film. A slow axis angle of the first uniaxial compensation film is 90 degrees, a slow axis angle of the second uniaxial compensation film is zero degrees, an in-plane phase difference of the first uniaxial compensation film is Ro=0, and an out-of-plane phase difference of the second uniaxial compensation film is Rth=0, wherein the second uniaxial compensation films are located close to the LCD panel, and the first uniaxial compensation films are located close to the first polarizing film or the second polarizing film.

A fifth preset LCD compensation simulation framework is shown in Table 7:

TABLE 7

| | |
|---|---|
| first polarizing film | absorption axis at 90 degrees |
| first uniaxial compensation film (Ro = 0) | slow axis at 0 degrees |
| second uniaxial compensation film (Rth = 0) | slow axis at 0 degrees |
| third uniaxial compensation film (Ro = 0) | slow axis at 0 degrees |
| LCD panel | |
| third uniaxial compensation film (Ro = 0) | slow axis at 90 degrees |
| second uniaxial compensation film (Rth = 0) | slow axis at 90 degrees |
| first uniaxial compensation film (Ro = 0) | slow axis at 90 degrees |
| second polarizing film | absorption axis at 0 degrees |

Referring to Table 7, a first preset compensation film simulation framework of the fifth preset LCD compensation simulation framework includes a first uniaxial compensation film, a second uniaxial compensation film, and a third uniaxial compensation film. A slow axis angle of each of the first uniaxial compensation film, the second uniaxial compensation film, and the third uniaxial compensation film is zero degrees, an in-plane phase difference of each of the first uniaxial compensation film and the third uniaxial compensation film is Ro=0, and an out-of-plane phase difference of the second uniaxial compensation film is Rth=0. A second preset compensation film simulation framework of the fifth preset LCD compensation simulation framework includes a first uniaxial compensation film, a second uniaxial compensation film, and a third uniaxial compensation film. A slow axis angle of each of the first uniaxial compensation film, the second uniaxial compensation film, and the third uniaxial compensation film is 90 degrees, an in-plane phase difference of each of the first uniaxial compensation film and the third uniaxial compensation film is Ro=0, and an out-of-plane phase difference of the second uniaxial compensation film is Rth=0, wherein the third uniaxial compensation films are located close to the LCD panel, and the first uniaxial compensation films are located close to the first polarizing film or the second polarizing film.

A sixth preset LCD compensation simulation framework is shown in Table 8:

TABLE 8

| | |
|---|---|
| first polarizing film | absorption axis at 90 degrees |
| first uniaxial compensation film (Ro = 0) | slow axis at 0 degrees |
| second uniaxial compensation film (Rth = 0) | slow axis at 90 degrees |
| third uniaxial compensation film (Ro = 0) | slow axis at 0 degrees |
| LCD panel | |
| third uniaxial compensation film (Ro = 0) | slow axis at 90 degrees |
| second uniaxial compensation film (Rth = 0) | slow axis at 0 degrees |
| first uniaxial compensation film (Ro = 0) | slow axis at 90 degrees |
| second polarizing film | absorption axis at 0 degrees |

Referring to Table 8, a first preset compensation film simulation framework of the sixth preset LCD compensation simulation framework includes a first uniaxial compensation film, a second uniaxial compensation film, and a third uniaxial compensation film. A slow axis angle of each of the first uniaxial compensation film and the third uniaxial compensation film is zero degrees, a slow axis angle of the second uniaxial compensation film is 90 degrees, an in-plane phase difference of each of the first uniaxial compensation film and the third uniaxial compensation film is Ro=0, and an out-of-plane phase difference of the second uniaxial compensation film is Rth=0. A second preset compensation film simulation framework of the sixth preset LCD compensation simulation framework includes a first uniaxial compensation film, a second uniaxial compensation film, and a third uniaxial compensation film. A slow axis angle of each of the first uniaxial compensation film and the third uniaxial compensation film is 90 degrees, a slow axis angle of the second uniaxial compensation film is 0 degrees, an in-plane phase difference of each of the first uniaxial compensation film and the third uniaxial compensation film is Ro=0, and an out-of-plane phase difference of the second uniaxial compensation film is Rth=0, wherein the third uniaxial compensation films are located close to the LCD panel, and the first uniaxial compensation films are located close to the first polarizing film or the second polarizing film.

Obtain at least a preset simulation target curve by simulating the preset LCD compensation simulation frameworks. Specifically, one can refer to the method of simulating the standard LCD compensation simulation framework when simulating the preset LCD compensation simulation frameworks. That is, specific large viewing angles in the dark state can be selected for the simulation, for example, under the large viewing angles of (45, 60) degrees in the dark state, an out-of-plane phase difference Rth of each of the preset compensation simulation film frameworks in the preset LCD compensation simulation framework is set unchanged, corresponding brightness and chromaticity are obtained by changing an in-plane phase difference Ro of each of the preset compensation film simulation frameworks, and the preset simulation target curve is output according to correlations between the in-plane phase difference Ro and brightness and chromaticity. Please refer to FIGS. 4 to 6. The preset simulation target curve includes the brightness curve, the chromaticity X curve, and the chromaticity Y curve. As the schematic relationship diagram of the in-plane phase difference Ro and the brightness shown in FIG. 4, brightness curves A1, B1, C1, D1, E1, F1 represent different brightness values corresponding to different in-plane phase differences Ro of the first preset LCD compensation simulation framework, the second preset LCD compensation simulation framework, the third preset LCD compensation simulation framework, the fourth preset LCD compensation simulation framework, the fifth preset LCD compensation simulation framework, and the sixth preset LCD compensation simulation framework, respectively. As the schematic relationship diagram of the in-plane phase difference Ro and chromaticity X shown in FIG. 5, chromaticity X curves A2, B2, C2, D2, E2, F2 represent different chromaticity values X corresponding to different in-plane phase differences Ro of the first preset LCD compensation simulation framework, the second preset LCD compensation simulation framework, the third preset LCD compensation simulation framework, the fourth preset LCD compensation simulation framework, the fifth preset LCD compensation simulation framework, and the sixth preset LCD compensation simulation framework, respectively. As the schematic relationship diagram of the in-plane phase difference Ro and chromaticity Y shown in FIG. 6, chromaticity Y curves A3, B3, C3, D3, E3, F3 represent different chromaticity values Y corresponding to different in-plane phase differences Ro of the first preset LCD compensation simulation framework, the second preset LCD compensation simulation framework, the third preset LCD compensation simulation framework, the fourth preset LCD compensation simulation framework, the fifth preset LCD compensation simulation framework, and the sixth preset LCD compensation simulation framework, respectively.

Determine a target compensation film framework from the at least two preset compensation film simulation frameworks according to a comparison result of the preset simulation target curve and the standard simulation target curve.

Specifically, please continue referring to FIGS. 4 to 6. A correlation between the preset simulation target curve and the standard simulation target curve is shown as the brightness curve, the chromaticity X curve, the chromaticity Y curve of the standard LCD compensation simulation framework and the curves of the preset LCD compensation simulation frameworks in FIGS. 4 to 6. By comparing the brightness curves in FIG. 4, the chromaticity X curves in FIG. 5, and the chromaticity Y curves in FIG. 6, it can be seen that the brightness curve E1, the chromaticity X curve E2, and the chromaticity Y curve E3 of the fifth preset LCD compensation simulation framework are most consistent with the brightness curve O1, the chromaticity X curve O2, and the chromaticity Y curve O3 of the standard compensation film simulation framework.

In addition, each of the standard LCD compensation simulation framework and the preset LCD compensation simulation framework includes an LCD panel. Standard panel parameters of the LCD panel of the standard LCD compensation simulation framework are related to preset panel parameters of the LCD panel of the preset LCD compensation simulation framework. The standard panel parameters and the preset panel parameters both include liquid crystal optical path difference, etc. The correlation between the standard panel parameters and the preset panel parameters means that the standard panel parameters and the preset panel parameters are the same. Therefore, when compensating for a specific liquid crystal optical path difference, the preset compensation film simulation frameworks of the fifth preset LCD compensation simulation framework can achieve a same compensation effect as the standard compensation film simulation frameworks of the standard LCD compensation simulation framework.

Further, according to the simulation request for selecting the target compensation film framework, the first preset compensation film simulation framework and the second preset compensation film simulation framework of the fifth preset LCD compensation simulation framework are the target compensation film framework.

Step S302: creating a target LCD compensation framework based on the target compensation film framework.

Specifically, the target compensation film framework is the first preset compensation film simulation framework and the second preset compensation film simulation framework of the fifth preset LCD compensation simulation framework. Accordingly, the target LCD compensation framework being created based on the target compensation film framework is the fifth preset LCD compensation simulation framework as described in the above embodiment. Please refer to Table 7. The target LCD compensation framework (i.e., the fifth preset LCD compensation simulation framework) includes the LCD panel, the first polarizing film, the second polarizing film, the first target compensation film framework disposed between the first polarizing film and the LCD panel, and the second target compensation film framework disposed between the second polarizing film and the LCD panel. An angle between a slow axis of each of film layers included in the first target compensation film framework and an absorption axis of the first polarizing film, and an angle between a slow axis of each of film layers included in the second target compensation film framework and an absorption axis of the second polarizing film are 90 degrees, respectively, wherein the absorption axis angle of the first polarizing film is 90 degrees, and the absorption axis angle of the second polarizing film is zero degrees.

Step S303: obtaining panel setting parameters, and setting the LCD panel in the target LCD compensation framework according to the panel setting parameters.

Specifically, the panel setting parameters are obtained, and the panel setting parameters include LCD optical path difference, etc., and the LCD panel of the target LCD compensation framework is set according to the liquid crystal optical path difference.

Step S304: adjusting thicknesses of uniaxial compensation films included in each of the first target compensation film framework and the second target compensation film framework according to a preset adjustment method, and determining corresponding influence parameters.

Specifically, an LCD compensation simulation interface is displayed, and the thicknesses of the uniaxial compensation films in the first target compensation film framework are obtained through the LCD compensation simulation interface, so as to adjust the thickness of a corresponding one of the uniaxial compensation films in the first target compensation film framework, and to determine corresponding influence parameters of the first target compensation film framework. The thicknesses of the uniaxial compensation films in the second target compensation film framework are obtained through the LCD compensation simulation interface, so as to adjust the thickness of a corresponding one of the uniaxial compensation films in the second target compensation film framework, and to determine corresponding influence parameters of the second target compensation film framework, wherein the influence parameters refer to compensation values of the first target compensation film framework or the second target compensation film framework, that is, the in-plane phase difference Ro and the out-of-plane phase difference Rth.

Specifically, please continue referring to Table 7. The first target compensation film framework includes the first uniaxial compensation film, the second uniaxial compensation film, and the third uniaxial compensation film. Thickness of the first uniaxial compensation film in the first target compensation film framework is obtained through the LCD compensation simulation interface, so as to adjust the thickness of the first uniaxial compensation film in the first target compensation film framework, and to determine a corresponding out-of-plane phase difference of the first uniaxial compensation film. Thickness of the second uniaxial compensation film in the first target compensation film framework is obtained through the LCD compensation simulation interface, so as to adjust the thickness of the second uniaxial compensation film in the first target compensation film framework, and to determine a corresponding in-plane phase difference of the second uniaxial compensation film, wherein the in-plane phase difference of the second uniaxial compensation film is also the in-plane phase difference of the first target compensation film framework. Thickness of the third uniaxial compensation film in the first target compensation film framework is obtained through the LCD compensation simulation interface, so as to adjust the thickness of the third uniaxial compensation film in the first target compensation film framework, and to determine a corresponding out-of-plane phase difference of the third uniaxial compensation film, wherein a sum of the out-of-plane phase difference of the first uniaxial compensation film and the out-of-plane phase difference of the third uniaxial compensation film is the out-of-plane phase difference of the first target compensation film framework.

The second target compensation film framework includes the first uniaxial compensation film, the second uniaxial compensation film, and the third uniaxial compensation film. Thickness of the first uniaxial compensation film in the second target compensation film framework is obtained through the LCD compensation simulation interface, so as to adjust the thickness of the first uniaxial compensation film in the second target compensation film framework, and to determine a corresponding out-of-plane phase difference of the first uniaxial compensation film. Thickness of the second uniaxial compensation film in the second target compensation film framework is obtained through the LCD compensation simulation interface, so as to adjust the thickness of the second uniaxial compensation film in the second target compensation film framework, and to determine a corresponding in-plane phase difference of the second uniaxial compensation film, wherein the in-plane phase difference of the second uniaxial compensation film is also the in-plane phase difference of the second target compensation film framework. Thickness of the third uniaxial compensation film in the second target compensation film framework is obtained through the LCD compensation simulation interface, so as to adjust the thickness of the third uniaxial compensation film in the second target compensation film framework, and to determine a corresponding out-of-plane phase difference of the third uniaxial compensation film, wherein a sum of the out-of-plane phase difference of the first uniaxial compensation film and the out-of-plane phase difference of the third uniaxial compensation film is the out-of-plane phase difference of the second target compensation film framework.

In one embodiment, the step of adjusting thicknesses of uniaxial compensation films included in each of the first target compensation film framework and the second target compensation film framework according to a preset adjustment method, and determining corresponding influence parameters may be performed through steps as follows:

displaying an LCD compensation simulation interface; obtaining the thicknesses of the uniaxial compensation films in the first target compensation film framework through the LCD compensation simulation interface, so as to adjust the thickness of a corresponding one of the uniaxial compensation films in the first target compensation film framework, and to determine corresponding influence parameters of the first target compensation film framework; adjusting the thicknesses of the corresponding uniaxial compensation films in the second target compensation film framework based on the thicknesses of the uniaxial compensation films in the first target compensation film framework; and determining influence parameters of the second target compensation film framework based on the influence parameters of the first target compensation film framework.

Specifically, please continue referring to Table 7. Each of the first target compensation film framework and the second target compensation film framework of the target LCD compensation framework (i.e., the fifth preset LCD compensation simulation framework) includes the third uniaxial compensation film. The third uniaxial compensation film of the first target compensation film framework and the third uniaxial compensation film of the second target compensation film framework are symmetric about the LCD panel, and compensation values of the first target compensation film framework and the second target compensation film framework are the same. Therefore, when the target LCD compensation framework is simulated, it is only necessary to adjust the thickness of the uniaxial compensation films in the first target compensation film framework, and to determine the influence parameters of the first target compensation film framework. Then, based on the thickness of the uniaxial compensation films in the first target compensation film framework and the influence parameters of the first target compensation film framework, directly determine the thickness of the uniaxial compensation film in the second target compensation film framework and the influence parameters of the second target compensation film framework, thereby reducing number of operations for obtaining the uniaxial compensation films and reducing workload of calculating the influence parameters.

Step 305: determining target parameters according to a simulation target.

Specifically, the simulation target includes a minimum, maximum, optimal, or fixed value of brightness and/or chromaticity, etc., and the target parameters are also the brightness value and chromaticity value corresponding to the simulation target.

In step S304, the compensation values of the target LCD compensation framework can be adjusted by adjusting the thickness of the uniaxial compensation films in the target compensation film frameworks. When simulating the target LCD compensation framework, different compensation values correspond to different brightness and chromaticity. When brightness is the simulation target, different brightness values can be obtained by adjusting the compensation values of the target LCD compensation framework. When chromaticity is the simulation target, different chromaticity values can be obtained by adjusting the compensation values of the target LCD compensation framework.

S306: outputting a simulation result according to correlations between the target parameters and the influence parameters.

Specifically, the target parameters are also the brightness values and the chromaticity values, the influence parameters are also the compensation values of the target LCD compensation framework, and different compensation values correspond to different brightness values and chromaticity values. Therefore, correlations between the target parameters and the influencing parameters are corresponding relationships between the compensation values and the brightness values and the chromaticity values. Appropriate compensation values can be determined by the corresponding relationships between the compensation values and the brightness values and the chromaticity values. Taking the corresponding relationship between the compensation values and the brightness values as an example, the larger the brightness value is, the more serious the light leakage in the dark state is. Therefore, it is necessary to obtain compensation values corresponding to a minimum brightness value area as the simulation result for outputting.

In the simulation method for liquid crystal display compensation of the present embodiment, the compensation film employs three layers of uniaxial compensation films, so that when simulating the target LCD compensation framework created with the target compensation film framework, it is only necessary to adjust the thickness of the uniaxial compensation films in the target compensation film framework to quickly perform independent simulations of the in-plane phase difference Ro and the out-of-plane phase difference Rth of the target compensation film frameworks, thereby overcoming the problem that current compensation film simulation design cannot achieve simple, fast, and separate settings for simulating compensation values Ro, Rth at will.

It should be noted that the in-plane phase difference and the out-of-plane phase difference of the target compensation film frameworks can be simply and quickly set at will, respectively, through the simulation method for liquid crystal display compensation of the above-mentioned embodiments. Therefore, after compensation values of a compensation film configured with a specific liquid crystal optical path difference are simply and quickly obtained through the simulation method for liquid crystal display compensation, other types of compensation films can also be designed through the compensation values, for example, such as biaxial compensation films, but in doing so refractive index of the biaxial compensation films need to be changed.

According to the above-mentioned embodiments, it can be understood that:

The present application provides a polarizer, a liquid crystal display module, and a simulation method for liquid crystal display compensation. A compensation film provided by the present application includes three layers of uniaxial compensation films. Each of the three uniaxial compensation films has a slow axis which is configured at a same slow axis angle and is perpendicular to an absorption axis of a polarizing film, and each of the three uniaxial compensation films has only an in-plane phase difference or an out-of-plane phase difference. In this manner, the present application only needs to adjust thickness of each layer of the compensation film when simulating the compensation film or preparing the polarizer, so that an in-plane phase difference and an out-of-plane phase difference of the compensation film can be separately set at will, which is simple and quick, thereby overcoming the problem that current compensation film simulation design cannot achieve simple, fast, and separate settings for simulating an in-plane phase difference and an out-of-plane phase difference of compensation values at will.

In the above-mentioned embodiments, the description of each embodiment has its own emphasis. For parts that are not described in detail in an embodiment, reference may be made to related descriptions of other embodiments.

The embodiments of the present application are described in detail above. Specific examples are used in this article to explain the principles and implementation of this application. The descriptions of the above embodiments are only used to help understand the technical solutions and core ideas of this application. Those of ordinary skill in the art should understand that: they can still modify the technical solutions described in the foregoing embodiments, or equivalently replace some of the technical features; and these modifications or replacements do not cause the essence of the corresponding technical solutions to deviate from the scope of the technical solutions of the embodiments of the present application.

What is claimed is:

1. A polarizer, comprising:
a polarizing film;
a compensation film disposed on a side of the polarizing film and comprising a first uniaxial compensation film, a second uniaxial compensation film, and a third uniaxial compensation film, wherein the second uniaxial compensation film is disposed between the first uniaxial compensation film and the third uniaxial compensation film, and an in-plane phase difference of the first uniaxial compensation film, an in-plane phase difference of the third uniaxial compensation film, and an out-of-plane phase difference of the second uniaxial compensation film are defined as a first preset value; and
a protective film disposed on a side of the polarizing film away from the compensation film;
wherein each of the first uniaxial compensation film, the second uniaxial compensation film, and the third uniaxial compensation film has a same slow axis angle, and an angle between a slow axis of each of the first uniaxial compensation film, the second uniaxial compensation film, and the third uniaxial compensation film and an absorption axis of the polarizing film is defined as a second preset value.

2. The polarizer of claim 1, wherein the first preset value is zero.

3. The polarizer of claim 1, wherein the second preset value is 90 degrees.

4. A liquid crystal display module, comprising:
a liquid crystal display panel;
a first polarizer disposed on a side of the liquid crystal display panel; and
a second polarizer disposed on a side of the liquid crystal display panel away from the first polarizer;
wherein the first polarizer comprises the polarizer of claim 1, and an absorption axis of a polarizing film included in the first polarizer is perpendicular to an absorption axis of a polarizing film included in the second polarizer.

5. The liquid crystal display module of claim 4, wherein the absorption axis of the polarizing film of the first polarizer is zero degrees with respect to an incident light direction.

6. The liquid crystal display module of claim 4, wherein the absorption axis of the polarizing film of the first polarizer is 90 degrees with respect to an incident light direction.

7. The liquid crystal display module of claim 4, wherein the second polarizer comprises the polarizer of claim 1.

8. The liquid crystal display module of claim 7, wherein the first preset value is zero.

9. The liquid crystal display module of claim 7, wherein the second preset value is 90 degrees.

10. A simulation method for liquid crystal display compensation, comprising:
selecting a target compensation film framework according to a simulation request, wherein the target compensation film framework comprises a first uniaxial compensation film, a second uniaxial compensation film, and a third uniaxial compensation film, wherein the second uniaxial compensation film is disposed between the first uniaxial compensation film and the third uniaxial compensation film, and an in-plane phase difference of the first uniaxial compensation film, an in-plane phase difference of the third uniaxial compensation film, and an out-of-plane phase difference of the second uniaxial compensation film are defined as a first preset value, and wherein each of the first uniaxial compensation film, the second uniaxial compensation film, and the third uniaxial compensation film has a same slow axis angle;
creating a target liquid crystal display (LCD) compensation framework based on the target compensation film framework, wherein the target LCD compensation framework comprises an LCD panel, a first polarizing film, a second polarizing film, a first target compensation film framework disposed between the first polarizing film and the LCD panel, and a second target compensation film framework disposed between the second polarizing film and the LCD panel, wherein an angle between a slow axis of each of film layers included in the first target compensation film framework and an absorption axis of the first polarizing film, and an angle between a slow axis of each of film layers included in the second target compensation film framework and an absorption axis of the second polarizing film are defined as a second preset value;
obtaining panel setting parameters, and setting the LCD panel in the target LCD compensation framework according to the panel setting parameters;
adjusting thicknesses of uniaxial compensation films included in each of the first target compensation film framework and the second target compensation film framework according to a preset adjustment method, and determining corresponding influence parameters;
determining target parameters according to a simulation target; and
outputting a simulation result according to correlations between the target parameters and the influence parameters.

11. The simulation method for the liquid crystal display compensation of claim 10, wherein the first preset value is zero.

12. The simulation method for the liquid crystal display compensation of claim 10, wherein the second preset value is 90 degrees.

13. The simulation method for the liquid crystal display compensation of claim 10, wherein the absorption axis of the first polarizing film is perpendicular to the absorption axis of the second polarizing film.

14. The simulation method for the liquid crystal display compensation of claim 13, wherein the absorption axis of the first polarizing film is zero degrees with respect to an incident light direction.

15. The simulation method for the liquid crystal display compensation of claim 13, wherein the absorption axis of the first polarizing film is 90 degrees with respect to an incident light direction.

16. The simulation method for the liquid crystal display compensation of claim 10, wherein the adjusting thicknesses of uniaxial compensation films included in each of the first target compensation film framework and the second target compensation film framework according to a preset adjustment method, and determining corresponding influence parameters comprises:
displaying an LCD compensation simulation interface;
obtaining the thicknesses of the uniaxial compensation films in the first target compensation film framework through the LCD compensation simulation interface, so as to adjust the thickness of a corresponding one of the uniaxial compensation films in the first target compensation film framework, and to determine corresponding influence parameters of the first target compensation film framework; and
obtaining the thicknesses of the uniaxial compensation films in the second target compensation film framework through the LCD compensation simulation interface, so as to adjust the thickness of a corresponding one of the uniaxial compensation films in the second target compensation film framework, and to determine corresponding influence parameters of the second target compensation film framework.

17. The simulation method for the liquid crystal display compensation of claim 10, wherein the adjusting thicknesses of uniaxial compensation films included in each of the first target compensation film framework and the second target compensation film framework according to a preset adjustment method, and determining corresponding influence parameters comprises:
displaying an LCD compensation simulation interface;
obtaining the thicknesses of the uniaxial compensation films in the first target compensation film framework through the LCD compensation simulation interface, so as to adjust the thickness of a corresponding one of the uniaxial compensation films in the first target compensation film framework, and to determine corresponding influence parameters of the first target compensation film framework;
adjusting the thicknesses of the corresponding uniaxial compensation films in the second target compensation film framework based on the thicknesses of the uniaxial compensation films in the first target compensation film framework; and
determining influence parameters of the second target compensation film framework based on the influence parameters of the first target compensation film framework.

18. The simulation method for the liquid crystal display compensation of claim 16, wherein the obtaining the thicknesses of the uniaxial compensation films in the first target compensation film framework through the LCD compensation simulation interface, so as to adjust the thickness of a corresponding one of the uniaxial compensation films in the first target compensation film framework, and to determine corresponding influence parameters of the first target compensation film framework comprises:
obtaining thicknesses of a first uniaxial compensation film in the first target compensation film framework through the LCD compensation simulation interface, so as to adjust the thickness of the first uniaxial compensation film in the first target compensation film framework, and to determine a corresponding out-of-plane phase difference of the first uniaxial compensation film;
obtaining thicknesses of a second uniaxial compensation film in the first target compensation film framework through the LCD compensation simulation interface, so as to adjust the thickness of the second uniaxial compensation film in the first target compensation film framework, and to determine a corresponding in-plane phase difference of the second uniaxial compensation film, wherein the in-plane phase difference of the second uniaxial compensation film doubles as an in-plane phase difference of the first target compensation film framework; and
obtaining thicknesses of a third uniaxial compensation film in the first target compensation film framework through the LCD compensation simulation interface, so as to adjust the thickness of the third uniaxial compensation film in the first target compensation film framework, and to determine a corresponding out-of-plane phase difference of the third uniaxial compensation film, wherein a sum of the out-of-plane phase difference of the first uniaxial compensation film and the out-of-plane phase difference of the third uniaxial compensation film doubles as an out-of-plane phase difference of the first target compensation film framework.

19. The simulation method for the liquid crystal display compensation of claim 10, wherein prior to the selecting a target compensation film framework according to a simulation request, the simulation method further comprises:
obtaining a standard compensation film simulation framework;
creating a standard LCD compensation simulation framework based on the standard compensation film simulation framework;
obtaining a standard simulation target curve by simulating the standard LCD compensation simulation framework;
obtaining at least two preset compensation film simulation frameworks;
creating preset LCD compensation simulation frameworks, respectively, based on the at least two preset compensation film simulation frameworks;
obtaining at least a preset simulation target curve by simulating the preset LCD compensation simulation framework; and
determining the target compensation film framework from the at least two preset compensation film simulation frameworks according to a comparison result of the preset simulation target curve and the standard simulation target curve.

20. The simulation method for the liquid crystal display compensation of claim 19, wherein each of the standard LCD compensation simulation framework and the preset LCD compensation simulation framework comprises the LCD panel, and standard panel parameters of the LCD panel of the standard LCD compensation simulation framework are related to preset panel parameters of the LCD panel of the preset LCD compensation simulation framework.
